(19) United States
(12) Patent Application Publication
(10) Pub. No.: US 2008/0211376 A1
(43) Pub. Date: Sep. 4, 2008

(54) Electron gun, electron beam exposure apparatus, and exposure method

(76) Inventors: Hiroshi Yasuda, Tokyo (JP); Takeshi Haraguchi, Tokyo (JP)

Correspondence Address: MURAMATSU & ASSOCIATES, Suite 310, 114 Pacifica, Irvina, CA, 92618, US

(21) Appl. No.: 12/075,067

(22) Filed: Mar. 7, 2008

Related U.S. Application Data
(63) Continuation of application No. PCT/JP2007/053101, filed on Feb. 20, 2007.

(51) Int. Cl. H01J 29/48

(52) U.S. Cl. 313/414

(57) ABSTRACT

An electron gun having an electron source emitting electrons includes: an acceleration electrode which accelerates the electrons; an extraction electrode which has a spherical concave surface having the center on an optical axis and facing the electron emission surface, and which extracts an electron from the electron emission surface; and a suppressor electrode which suppresses electron emission from a side surface of the electron source. In the electron gun, an electric field is applied to the electron emission surface while the electron source is kept at a low temperature in such an extent that sublimation of a material of the electron source would not be caused, to cause the electron source to emit a thermal field emission electron.

### CROSS-REFERENCE TO RELATED APPLICATIONS

This application is a continuation of prior International Patent Application No. PCT/JP2007/053101, filed Feb. 20, 2007, the entire contents of which are incorporated herein by reference.

### BACKGROUND OF THE INVENTION

1. Field of the Invention

The present invention relates to an electron gun used in a lithography process for manufacturing a semiconductor device, an electron beam exposure apparatus provided with the electron gun, and an exposure method.

2. Description of the Prior Art

Recently, in order to improve the throughput in electron beam exposure apparatus, a variable rectangular opening or a plurality of mask patterns is prepared as a mask, and thus a pattern is selected by beam deflection to be transferred through exposure onto a wafer. As one of exposure methods using such a plurality of mask patterns, proposed is an electron beam exposure apparatus which carries out block exposure. In the block exposure, a pattern is transferred onto a sample surface in the following manner. Specifically, a beam is irradiated onto one pattern region, which is selected, by beam deflection, from a plurality of patterns provided in a mask, so that the cross-section of the beam is formed into the shape of the pattern. Thereafter, the deflection of the beam passed through the mask is restored by a deflector in the later stage. After that, the pattern is reduced in size with a constant reduction ratio determined by an electron-optical system, and then transferred onto the sample surface.

In addition, in such an exposure apparatus, it is also important to secure the accuracy of line width in order to improve throughput. To secure the accuracy of line width, the intensity of electron beam to be emitted from an electron gun is required not to change with time. If the intensity of electron beam changes and is weakened with time, the extent of exposure is gradually reduced. Moreover, if an exposure time is increased to supplement the weakened intensity, control of the exposure system becomes troublesome, and the throughput is deteriorated.

Methods for emitting electrons from an electron gun are broadly divided into a thermionic emission type and a field emission type. Of these, the thermionic emission type electron gun is configured of a cathode, which emits electrons by being heated, a wehnelt, which forms an electron beam by converging the electrons emitted from the cathode, and an anode, which accelerates the converged electron beam.

When the above-described thermionic emission type electron gun is used, the substance composing the chip is sublimated and evaporated along with the emission of electrons from an electron source (chip) used in the electron gun, so that the amount of the substance is reduced. This reduction causes a phenomenon that an electron emission portion is deformed. To prevent an occurrence of this phenomenon, a various kinds of measures are considered. For example, Japanese Patent Application Laid-open Publication No. Hei 8-184699 discloses an electron gun. In the electron gun, a surface of a chip is covered with a film having a two-layer structure formed of tungsten (W) and rhenium (Re), so as to reduce depletion of the chip.

As described above, when the thermionic emission type electron gun is used, not only are electrons emitted from the chip configuring the electron gun, but also the chip substrate per se is sublimated, in some cases. This is considered to be because in the case of thermionic emission, electrons are emitted by setting the temperature of the chip to be equal to or higher than the sublimation starting temperature of an electron generating substance, and thus the sublimation is caused in the chip.

With this sublimation, the shape of the chip emitting electrons is changed, and hence, a variable rectangular beam or a block pattern beam cannot be evenly irradiated. As a result, the intensity of an electron beam to be emitted is reduced. For example, in the case of the thermionic emission type electron gun in which lanthanum hexaboride (LaB₆) is used as the chip, and in which the temperature is set at 1500° C., sublimation of 10 μm was generated after one-month use.

In addition, with the above-described sublimation, the chip substance, such as LaB₆ or cerium hexaboride (CeB₆), adheres onto the back side of a grid. This adherent becomes whiskers that may cause micro discharge due to electrons charged on the whiskers. If such micro discharge is caused, a phenomenon is caused that the amount and irradiation position of an electron beam are unstable, and that the electron beam exposure apparatus cannot be used normally. Furthermore, adjustment and the like of the apparatus take longer time, and thus, throughput is reduced. The biggest problem is that the reliability may be lost due to a pattern rendered at the time when micro discharge is caused. Thus, to eliminate the micro discharge in the vicinity of the electron gun is essential to provide an electron beam exposure apparatus with high reliability. In other words, an essential development requirement to provide an electron beam exposure apparatus with high reliability and stability is to reduce the amount of sublimation of the material for the electron gun as much as possible.

Note that in Japanese Patent Application Laid-open Publication No. Hei 8-184699, the surface of the chip is covered with the film having the two-layer structure formed of tungsten and rhenium to reduce the depletion of the chip. However, the shape of an electron emission surface which is not covered with the two-layer structure cannot be prevented from being changed due to the sublimation.

### SUMMARY OF THE INVENTION

The present invention has been made in view of the foregoing problems associated with the prior art. Accordingly an object of the present invention is to provide: an electron gun in which the amount of sublimation due to the heat of an electron source emitting electrons can be reduced, and which can be stably used for a long time; an electron beam exposure apparatus using the electron gun; and an exposure method.

The above-described problems can be solved by an electron gun including an electron source which emits an electron; an acceleration electrode which is disposed to face an electron emission surface of the electron source, and which accelerates the electron; an extraction electrode which is disposed between the electron emission surface and the acceleration electrode, which has a spherical concave surface having the center on an optical axis, and facing the electron emission surface, and which extracts an electron from the electron emission surface; and a suppressor electrode, which is disposed on the side opposite from the extraction electrode in relation to the electron emission surface, and which suppresses electron emission from a side surface of the electron source. The electron gun is characterized in that an electric field is applied to the electron emission surface while the electron source is kept at a low temperature in such an extent that sublimation of a material of the electron source would not be caused, to cause the electron source to emit a thermal field emission electron.

In the electron gun according to the above-described aspect, the material of the electron source may be any one of lanthanum hexaboride (LaB₆) and cerium hexaboride (CeB₆), and the side surface of the electron source other than the electron emission surface at a tip portion of the electron source may be covered with a substance with a large work function, the substance being different from a substance constituting the electron source. In addition, the different substance may be carbon, and the temperature may be set in a range from 1100° C. to 1450° C.

Moreover, in the electron gun according to the aspect, the extraction electrode may be disposed at a distance of 2 mm or less from the electron emission surface, and an electrostatic lens electrode may be provided between the extraction electrode and the acceleration electrode.

In the present invention, a portion of the extraction electrode, the portion facing the electron emission surface, is formed to be a spherical concave surface. Thereby, potential distribution between the extraction electrode and the electron emission surface can be spherical, and hence, the potential in the vicinity of the electron emission surface can be extremely large. Accordingly, even though the thermionic emission type electron gun is used and operated at a low temperature, the high luminance of the electron beam can be obtained.

In addition, in the present invention, only the electron emission surface at the tip portion of the chip of the electron source is exposed while a side portion other than that is covered with a dissimilar substance. For example, when LaB₆ is used as an electron generating material, this dissimilar substance is, for example, carbon (C). Since the electron gun having such an electron source is operated at a low temperature, sublimation of the chip hardly occurs. Thus, the electron gun can be stably used for a long time without the electron emission surface of the electron source being deformed.

In addition, even if an intense electric field is applied to operate the electron gun at such a temperature that the sublimation of the chip is not caused, electrons are not emitted from the side surface of the electron source because the side surface of the electron source is covered with carbon. With this configuration, the form of the electron beam is not changed, and also, this configuration can prevent a phenomenon that the degree of vacuum is lowered due to an unnecessary portion being heated to a high temperature.

Furthermore, the above-described problems are solved by an electron beam exposure method using an electron beam exposure apparatus including the electron gun according to the aspect and any one of the above-described characteristics. The electron beam exposure method is characterized in that a voltage is applied so that the potential of the extraction electrode would be lower than the potential of the tip portion of the electron source, and a voltage of the electron source whose absolute value is larger than a voltage value normally used is applied to the entire electron source for a predetermined period of time; thereafter the voltage of the electron source is returned to the voltage value normally used; and then a voltage is applied so that the potential of the extraction electrode would be higher than that of the tip portion of the electron source, to carry out exposure.

An example of causes of considerable deterioration in reliability of an apparatus is electric discharge occurring through dusts which adhere onto a wehnelt and insulator of the electron gun, and onto which electrons are charged. As a measure against this problem, a method referred to as conditioning is generally used.

In the present invention, at the time of conditioning before exposure, the potential of the extraction electrode is set to be lower than that of the electron source. Consequently, even if conditioning is carried out, electrons are not emitted from the electron source, and the electron source can be prevented from being melted or damaged.

### BRIEF DESCRIPTION OF THE DRAWINGS

FIG. 1 is a configurational view of an electron beam exposure apparatus according to the present invention;

FIG. 2 is a configurational view of an electron gun according to the present invention;

FIG. 3 is a graph showing one example of potential distribution between electrodes configuring the electron gun;

FIG. 4 is a cross-sectional view showing the shape of an extraction electrode;

FIGS. 5A and 5B are views each showing one example of potential distribution between an electron emission surface and the extraction electrode;

FIG. 6 is a graph showing a relationship of a distance from the electron emission surface and the intensity of electric field;

FIG. 7 is a configurational view of an electron source and electrode according to the electron gun of FIG. 2;

FIGS. 8A and 8B are cross-sectional views each showing the shape of a tip portion of the electron source;

FIG. 9 is a cross-sectional view of an electron source and electrode of another embodiment according to the electron gun of FIG. 2; and

FIG. 10 is a cross-sectional view of the electron source illustrating a region which restricts electron emission.

### DESCRIPTION OF THE PREFERRED EMBODIMENT

A preferred embodiment of the present invention will be described below by referring to the drawings.

Firstly, the configuration of an electron beam exposure apparatus will be described. Subsequently, the configuration of an electron gun will be described, and then the configuration of an electron source of the electron gun, which is a characteristic feature of the present invention, will be described. Thereafter, an exposure method of the exposure apparatus using the electron gun of the present invention will be described. Then, a method for forming, on a surface of the electron source, a region which restricts electron distribution will be described. Lastly, effects of a case where the electron gun according to the present embodiment is used will be described.

### (Configuration of the Electron Beam Exposure Apparatus)

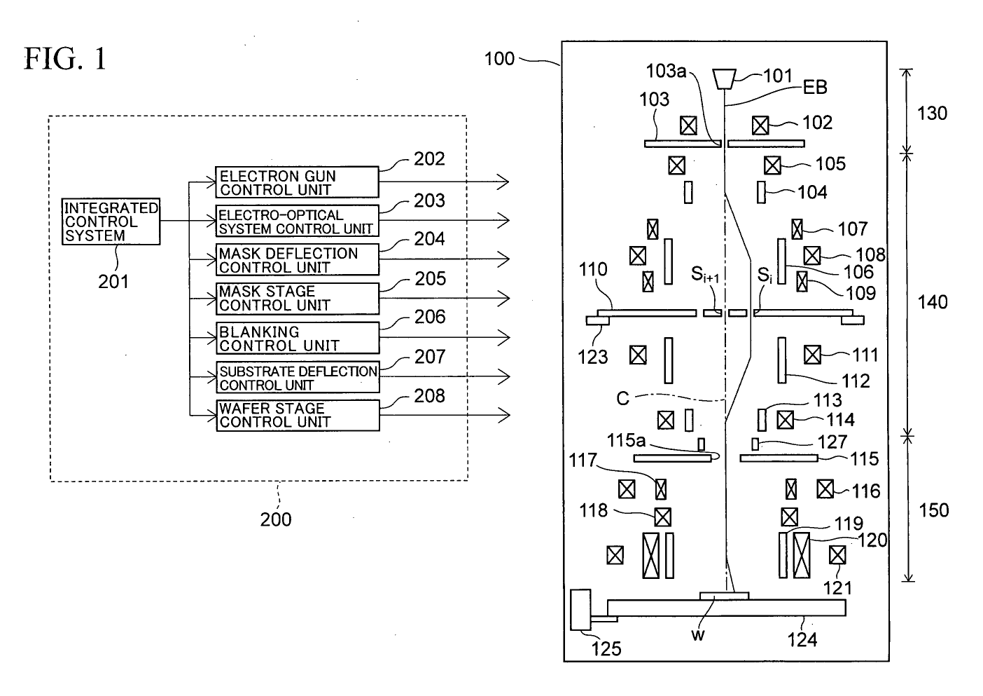

FIG. 1 shows a configurational view of an electron beam exposure apparatus according to the present embodiment.

This electron beam exposure apparatus is broadly divided into an electron-optical system column 100 and a control unit 200, which controls each unit of the electron-optical system column 100. Of these, the electron-optical system column 100 is configured of an electron beam generation unit 130, a mask deflection unit 140, and a substrate deflection unit 150, and the inside of the electro-optical system column 100 is decompressed.

In the electron beam generation unit 130, an electron beam EB generated in an electron gun 101 is converged by a first electromagnetic lens 102, and then passes through a rectangular aperture 103a of a beam-shaping mask 103. Thereby, the cross section of the electron beam EB is shaped into a rectangular shape.

After that, an image of the electron beam EB is formed onto an exposure mask 110 by a second electromagnetic lens 105 of the mask deflection unit 140. Then, the electron beam EB is deflected by first and second electrostatic deflectors 104 and 106 to a specific pattern Si formed on the exposure mask 110, and the cross-sectional shape thereof is shaped into the shape of the pattern Si.

Note that the exposure mask 110 is fixed to a mask stage 123, but the mask stage 123 is movable in a horizontal plane. Thus, in the case of using a pattern S which lies over a region exceeding the deflection range (beam deflection region) of the first and second electrostatic deflectors 104 and 106, the pattern S is moved to the inside of the beam deflection region by moving the mask stage 123.

Third and fourth electromagnetic lenses 108 and 111, which are respectively disposed above and below the exposure mask 110, have the role of further forming an image of the electron beam EB onto a substrate W by adjusting the amounts of currents flowing therethrough after converging the electron beam EB on the exposure mask 110.

The electron beam EB passed through the exposure mask 110 is returned to an optical axis C by the deflection operations of the third and fourth electrostatic deflectors 112 and 113. Thereafter, the size of the electron beam EB is reduced by a fifth electromagnetic lens 114.

In the mask deflection unit 140, first and second correction coils 107 and 109 are provided. These correction coils 107 and 109 correct beam deflection errors generated in the first to fourth electrostatic deflectors 104, 106, 112, and 113.

After that, the electron beam EB passes through an aperture 115a of a shield plate 115 configuring the substrate deflection unit 150, and are projected onto the substrate W by first and second projection electromagnetic lenses 116 and 121. Thereby, an image of the pattern of the exposure mask 110 is transferred onto the substrate W at a predetermined reduction ratio, for example, a reduction ratio of 1/10.

In the substrate deflection unit 150, a fifth electrostatic deflector 119 and an electromagnetic deflector 120 are provided. The electron beam EB is deflected by these deflectors 119 and 120. Thus, an image of the pattern of the exposure mask is projected onto a predetermined position on the substrate W.

Furthermore, in the substrate deflection unit 150, third and fourth correction coils 117 and 118 are provided for correcting deflection errors of the electron beam EB on the substrate W.

The substrate W is fixed to a wafer stage 124, which is movable in horizontal directions by a driving unit 125, such as a motor. The entire surface of the substrate W can be exposed to light by moving the wafer stage 124.

On the other hand, the control unit 200 has an electron gun control unit 202, an electro-optical system control unit 203, a mask deflection control unit 204, a mask stage control unit 205, a blanking control unit 206, a substrate deflection control unit 207, and a wafer stage control unit 208. Of these, the electron gun control unit 202 performs control of the electron gun 101 to control the acceleration voltage of the electron beam EB, beam emission conditions, and the like. Furthermore, the electro-optical system control unit 203 controls the amounts of currents flowing into the electromagnetic lenses 102, 105, 108, 111, 114, 116, and 121, and adjusts the magnification, focal point, and the like of the electro-optical system configured of these electromagnetic lenses. The blanking control unit 206 deflects the electron beam EB generated before the start of exposure onto the shield plate 115 by controlling the voltage applied to a blanking electrode 127. Thereby, the electron beam EB is prevented from being irradiated to the substrate W before exposure.

The substrate deflection control unit 207 controls the voltage applied to the fifth electrostatic deflector 119 and the amount of a current flowing into the electromagnetic deflector 120, so that the electron beam EB would be deflected onto a predetermined position on the substrate W. The wafer stage control unit 208 moves the substrate W in horizontal directions by adjusting the driving amount of the driving unit 125, so that the electron beam EB would be irradiated to a desired position on the substrate W. The above-described units 202 to 208 are integrally controlled by an integrated control system 201, such as a workstation.

### (Configuration of the Electron Gun)

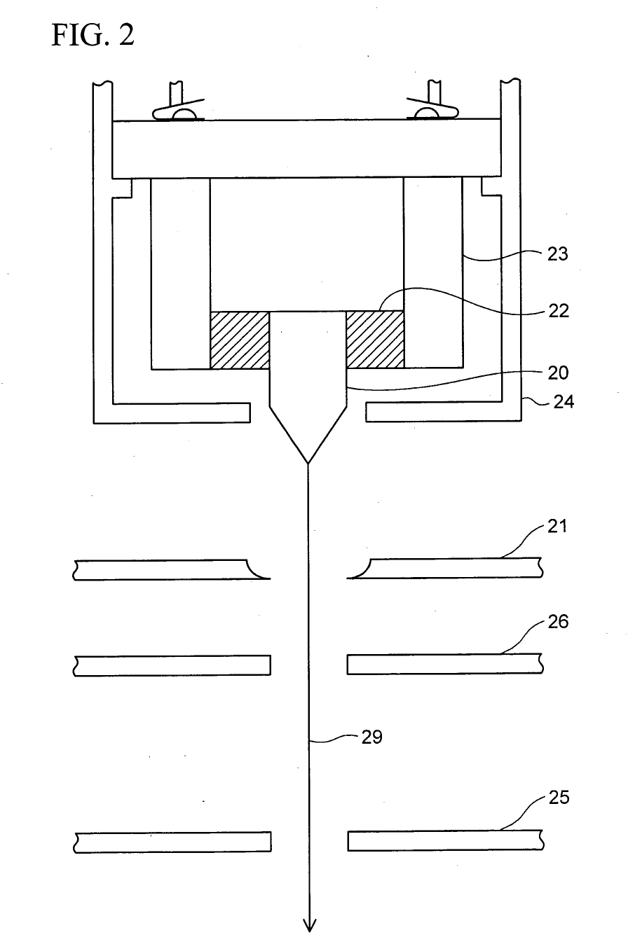

FIG. 2 shows a configurational view of the electron gun 101. In the present embodiment, a thermal field emission type electron gun 101 is used. The electron gun 101 has: an electron source 20; an extraction electrode 21; an acceleration electrode 25 provided below the extraction electrode 21; an electron source heating heater 22, which is provided on both sides of the electron source 20, and which is made of carbon; a supporting member 23 supporting the electron source 20 and the electron source heating heater 22; and a suppressor electrode 24 supporting and surrounding the supporting member 23. The electron source uses, for example, single crystal LaB₆ or CeB₆.

The extraction electrode 21 is an electrode which forms an intense electric field at the tip of the electron source 20, and to which a voltage for causing electrons to be emitted from the electron source 20 is applied. The extraction electrode 21 is provided in a position which is, for example, 2 mm or less from the electron emission surface of the electron source 20.

The acceleration electrode 25 is an electrode to which a voltage for accelerating electrons emitted from the electron source 20 is applied, and which is provided in a distance of, for example, 20 mm from the extraction electrode 21.

In the electron gun 101 having the above-described configuration, the electron gun control unit 202 heats the electron source 20 to be 1300° C. by continuously applying currents for heating the electron source to the electron source heating heater 22. Then, in a state where the electron source 20 is kept at a constant temperature, an intense electric field is applied between the suppressor electrode 24 and the extraction electrode 21 to extract electrons from the electron source 20. Furthermore, a voltage is applied to the acceleration electrode 25 provided below the extraction electrode 21 so as to extract an electron beam 29 with predetermined energy. The electron beam 29 is emitted onto the substrate W which is fixed on the wager stage 124, and on which a resist is coated, so that electron beam exposure is made.

Here, the voltage to be applied to the suppressor electrode 24 is in a range from −0.1 kV to −0.5 kV, and the voltage to be applied to the extraction electrode 21 is in a range from 2.0 kV to 4.0 kV. These voltages are values corresponding to the potentials of the electron source 20. Thus, since the value of the electron source 20 in relation to the true earth ground is normally −50 kV, the values of the voltages will be ones to which −50 kV is added.

Note that in the present embodiment, electric discharge is caused by applying an intense electric field while heating the electron source 20. Thus, adsorption of gas molecules on a surface of the electron source 20 can be prevented, and hence, decrease of luminance of the electron beam can be prevented.

In addition to the above-described electrodes, an electrostatic lens electrode 26 may be provided between the extraction electrode 21 and the acceleration electrode 25. The electrostatic lens electrode 26 is an electrode for adjusting an opening angle for electron emission emitted from the electron source 20, and such a voltage that electrons would not be emitted onto the acceleration electrode 25 is applied to the electrostatic lens electrode 26.

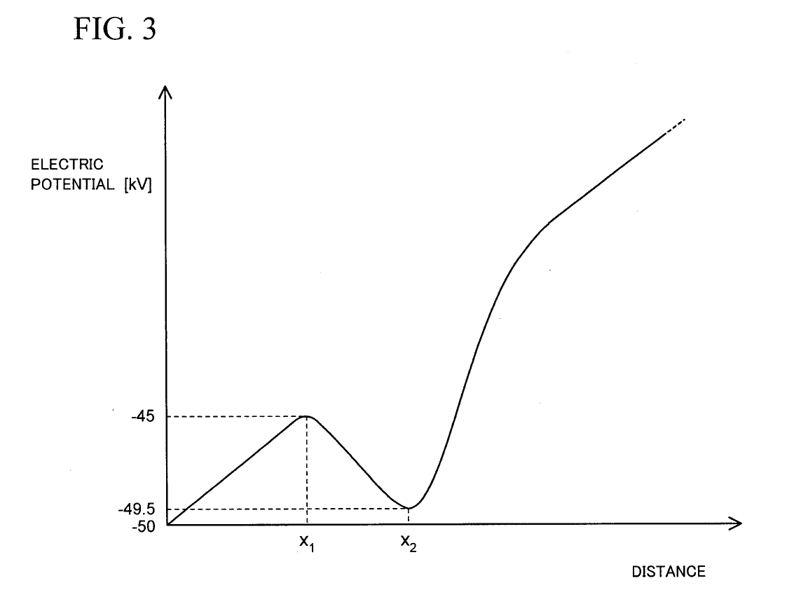

FIG. 3 is a graph showing one example of potential distribution between the electrodes configuring the electron gun. The lateral axis of FIG. 3 shows a distance from the electron emission surface of the electron source 20, and the vertical axis shows an electric potential thereof. Reference numerals X1 and X2 in FIG. 3 respectively show the positions of the extraction electrode 21 and the electrostatic lens electrode 26. In addition, FIG. 3 shows a case where the electric potential of the acceleration electrode 25 is set to be 0 [kV] and the electric potential of the electron emission surface of the electron source 20 is set to be −50 [kV].

As shown in FIG. 3, an electron lens with a voltage which is slightly higher than a cathode voltage on the electron emission surface is formed in the position of the electrostatic lens electrode 26. Thereby, the opening angle for electron emission becomes smaller. Thus, it is possible that electrons would not be emitted onto the acceleration electrode 25. As a result, heat is not generated due to emission of the electron beam to the acceleration electrode 25, and thus, the degree of vacuum inside the exposure apparatus can be prevented from being decreased.

### (Configuration of the Extraction Electrode)

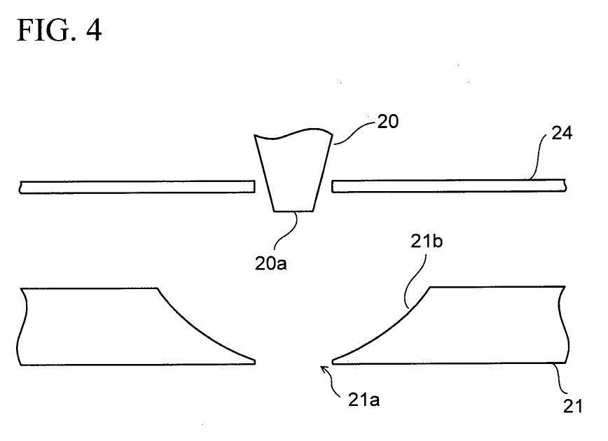

Next, the configuration of the extraction electrode 21 used in the present embodiment will be described by referring to FIG. 4.

In the electron beam exposure apparatus, it is important for improvement of throughput to increase luminance of the electron beam.

To increase the luminance of the electron beam, an intense electric field is applied to an electric emission surface 20a of the electron source 20. By applying the intense electric field to a surface of a conductive body, a potential barrier in which electrons are confined within the surface is lowered, and thus, a tunnel phenomenon of electron is caused. Thereby, the electrons can be emitted from the surface. Accordingly, if the intensity of negative electric field can be increased in a vicinity of the electron emission surface 20a, a large number of electrons can be emitted from the electron emission surface 20a.

In general, electrons are emitted from the electron source by using the extraction electrode 21. The inventors of the present invention paid attention to the shape of the extraction electrode 21 in order to increase the intensity of the electric field in the vicinity of the electron emission surface 20a.

FIG. 4 is a cross-sectional view showing the shape of the extraction electrode 21. As shown in FIG. 4, the extraction electrode 21 has an opening portion 21a in the center thereof, and a spherical concave surface 21b facing the electron source 20 and having the center on an optical axis. For example, the diameter of the electron emission surface 20a is 50 μm, and the diameter of the opening portion 21a of the extraction electrode 21 is 100 μm. In addition, the spherical concave surface 21b has the center on the optical axis, and is a portion of a spherical surface with a radius of 200 μm. A distance between the electron emission surface 20a and a lower surface of the extraction electrode 21 is 200 μm.

It will be described below that the spherical concave surface 21b is provided on the extraction electrode 21, so that the intensity of the electric field in the vicinity of the electron emission surface 20a can be increased.

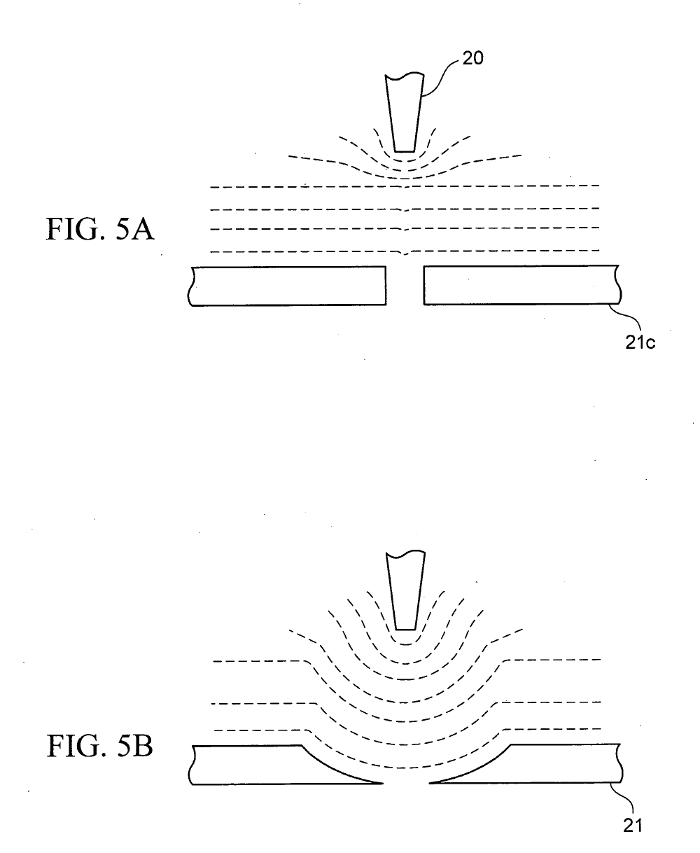

FIGS. 5A and 5B show potential distribution by an electric field between the electron emission surface 20a of the electron source 20 and the extraction electrode 21. In FIGS. 5A and 5B, broken lines show equipotential surfaces. FIG. 5A shows the potential distribution when the shape of the extraction electrode 21 is planar, while FIG. 5B shows the potential distribution when the extraction electrode 21 shown in FIG. 4 is used. As shown in FIG. 5A, if the shape of the extraction electrode 21 is planar, the equipotential surfaces are substantially parallel with the electrode in the vicinity of the extraction electrode 21, and the equipotential surfaces between the electron emission surface 20a and the equipotential surfaces in the vicinity of the extraction electrode 21 are also substantially parallel. In FIG. 5B, the electric field is applied towards the center of the sphere of the spherical concave surface 21b of the extraction electrode 21. Thus, the equipotential surfaces become spherical.

In this manner, the shape of the extraction electrode 21 facing the electron emission surface 20a of the electron source 20 is set to be a spherical concave surface, so that equipotential surfaces therebetween can be made spherical. In particular, the electron emission surface 20a is set to be spherical, so that electrons can appear to be emitted from one point. By setting electrons to be emitted from one point, the luminance of electron beam can be made extremely high.

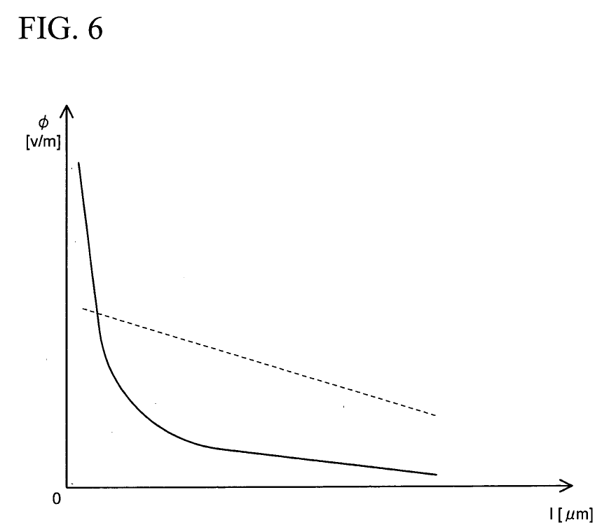

FIG. 6 is a graph showing a relationship between a distance from the electron emission surface 20a and an intensity of electric field. The broken line of FIG. 6 shows an intensity of electric field when the shape of the extraction electrode 21 is set to be planar, while the solid line of FIG. 6 shows an intensity of electric field when the shape of the extraction electrode 21 is set to be the shape shown in FIG. 4.

As shown in FIG. 6, when the shape of the extraction electrode 21 is set to be planar, the intensity of electric field becomes larger in proportion to the distance as it comes closer to the electron emission surface 20a. In contrast, when the shape of the extraction electrode 21 shown in FIG. 4 is used, the intensity of electric field shows an inversely proportional relationship to the distance from the electron emission surface. In this manner, the intensity of electric field can be extremely increased in the vicinity of the electron emission surface 20a by proving the spherical concave surface 21b on the extraction electrode 21.

Note that if the electron emission surface 20a is set to be planar instead of spherical, it cannot be set that electrons are emitted from one point. However, the electrons behave so as to come out from the circle of least confusion. Accordingly, the luminance of electron beam can be made higher than that of the case where the planar extraction electrode is used while depending on the size of the circle of least confusion.

As described above, when the extract electrode of the present embodiment is used, the intensity of electric field in the vicinity of the electron emission surface 20a can be made larger than that of a conventional one. Thereby, it is made possible that a large number of electrons can be emitted from the electron source 20.

Accordingly, by setting the surface, of the extraction electrode 21, facing the electron source 20, to be the spherical concave surface 21b, it is made possible that a value of the intensity of electric field in the vicinity of the electron emission surface 20a is made larger than that of a conventional one in a case where a voltage same as that of a conventional one is applied to the extraction electrode 21. In addition, even if a voltage to be applied to the extraction electrode 21 is set to be smaller than that to be conventionally applied, a value of the intensity of electric field in the vicinity of the electron emission surface 20a can be made equal to or larger than a conventional value. For example, voltages of 3.0 kV to 6.0 kV were applied to the conventional extraction electrode 21. However, it is only needed to apply voltages of 2.0 kV to 4.0 kV to the extraction electrode 21 of the present embodiment.

### (Configuration of the Electron Source)

Next, the configuration of the electron source 20 used in the present embodiment will be described.

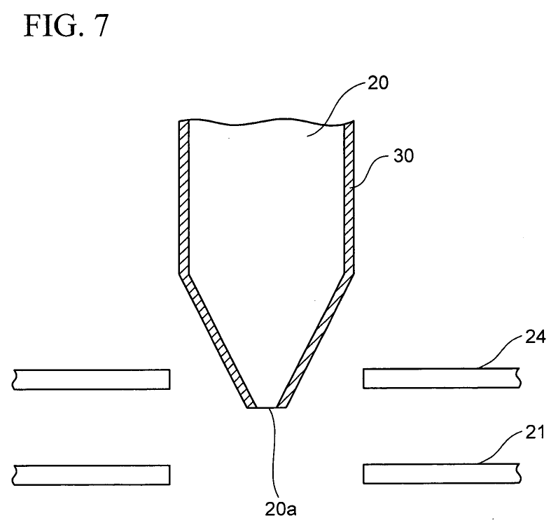

FIG. 7 is a cross-sectional view showing parts of the electron source 20 and electrodes, which configure the electron gun 101.

The tip portion of the electron source 20 has a conical shape, and the periphery thereof is covered with carbon 30. This carbon 30 is formed on the surface of the electron source 20 by, for example, a chemical vapor deposition (CVD) method. The material of the electron source 20 is exposed at the tip portion of the electron source 20, and the exposed portion is planarized.

The tip of the electron source 20 is disposed between the suppressor electrode 24 and the extraction electrode 21. The suppressor electrode 24 is applied of a zero or minus voltage, and has a function to shield electrons emitted from a portion other than the tip of the electron source 20. The intensity of electric field is determined by a voltage difference between the extraction electrode 21 and the suppressor electrode 24, the height and angle of the tip of the electron source 20, and the diameter of the planarized portion of the tip. The planarized tip portion of the electron source 20 is disposed so as to be parallel with the suppressor electrode 24 and the extraction electrode 21.

The electron source 20 has a conical tip, and the electron emission surface 20a emitting electrons is planarized. The periphery of the conical electron source 20 is covered with a material other than that configuring the electron source 20. It is desirable that the conical portion have a conical angle of 50° or less. Also, it is desirable that the surface emitting electrons have a diameter of 10 μm to 100 μm, generally 40 μm. In addition, it is desirable that the thickness of the material covering the periphery of the electron source 20 be 10 μm. However, the purposes of covering the periphery with the different material are (1) to prevent electrons from being emitted from the electron source 20, and (2) to suppress sublimation and evaporation of the material of the electron source 20 of a substrate. A value of the thickness of the covering material depends on the intensity of electric field and the material to be used. If depletion of the covering material due to evaporation at an operating temperature is small, it is better to have a thin covering material in order to increase the intensity of electric field.

A temperature to be applied to the electron source 20 is set to be a temperature lower than that of sublimating the material configuring the electron source 20. This temperature is, for example, 1100° C. to 1450° C. The reason is that in a case where a high temperature is applied in order to cause the electron source 20 to emit thermions, the electron source 20 is sublimated, and the electron emission surface 20a is depleted, which results in deformation, and thus the temperature is set in an extent of not causing sublimation. Even if a temperature is lowered, it is needed to obtain a current density and luminance which are obtained when the high temperature is applied. For this reason, the intense electric field is applied to the tip portion of the electron source 20 to extract electrons. For example, if a work function could be decreased by 0.3 eV in a case where a temperature is lowered by 200° C. from 1-500° C., the luminance of electron beam same as that obtained by the emission of thermions can be obtained without lowering the temperature from 1500° C. To emit electrons even if the work function is decreased by 0.3 eV, a high electric field is applied to the electron source 20.

In this case, electrons are extracted not only from the tip portion of the electron source 20, which is to be an electron emitting portion but also from a side portion of the conically-formed electron source 20. Accordingly, in some cases, the desired amount and shape of electron beam cannot be obtained, and the luminance of electron beam to be generated from the center portion is sometimes lowered because a space charge effect is generated by excessive electrons from the periphery. To avoid this phenomenon, the electron source 20 other than the electron emitting portion is covered with a material different from that configuring the electron source 20. As this different material, a substance having a work function larger than that of the material configuring the electron source 20 is selected.

Note that it is preferable that carbon (C), which does not react with LaB₆, and which has a work function larger than that of LaB₆, be used in the case of using LaB₆ as the electron source 20. Since this carbon reacts with oxygen, it is assumed that carbon would disappear due to evaporation as carbon oxide (CO₂) if the thickness of a carbon film is small. For this reason, it is preferable that the thickness of the carbon film be set at 2 μm to 10 μm. In the case of using CeB₆, having a characteristic similar to that of LaB₆, the same carbon material is effective to be used as a covering material.

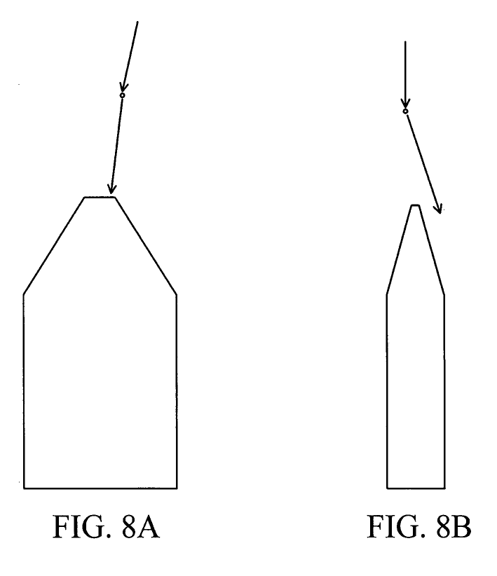

FIGS. 8A and 8B are cross-sectional views showing the electron source 20 with the different sizes of a conical angle at the tip portion of the electron source 20. In general, as the tip radius of the conical electron source 20 is smaller and the tip angle is smaller, an electric field is intensely concentrated at the tip portion to cause electrons inside the electron source 20 to easily pass through a work function barrier of the surface due to a tunnel phenomenon. However, when the tip portion is extremely narrow, the intensity of the electron source 20 per se becomes weaker. For this reason, an angle at the tip of the electron source 20 is determined by considering the intensities of the electron source 20 and the electric field.

FIG. 8A shows the case where the conical angle at the tip portion of the electron source 20 is set to be approximately 90°, while FIG. 8B shows the case where a conical angle at the tip portion of the electron source 20 is set to be smaller than that of FIG. 8A. Conventionally, as shown in FIG. 8A, the conical angle of approximately 90° is used at the tip portion of the electron source 20. As the tip angle is set to be smaller as shown in FIG. 8B, the electric field is more intensified. Thus, electrons can be easily emitted. Furthermore, fine particles of ions or the like present inside a body tube become unlikely to be collided with the tip portion of the electron source. Thus, it is made possible that the depletion and deformation effects of the surface of the electron source by ions and the like are reduced.

In the present embodiment, the angle of the tip portion of the electron source 20 is set to be approximately 30°. Though it depends on the material of the electron source 20 and sizes, such as the length and width, of the electron source 20, the electron source 20 of the present embodiment can be stably used for a longer period of time than that conventionally used.

### (Method for Forming a Region Restricting Electron Emission on the Surface of the Electron Source)

Next, a description will be given to a method for forming, on the electron source 20, a region which restricts the above-described electron emission.

Here, by using the electron source having the configuration shown in FIG. 8 as an example, a case where a single crystal of LaB₆ is used as the electron source 20 will be described.

Firstly, single crystal LaB₆ is processed so as to have a conical tip.

Subsequently, to form a region which restricts electron emission, carbon 30 is coated on the surface of the single crystal LaB₆. This coating may be carried out by any one of the CVD method, vacuum deposition method, sputtering method, and the like. At this time, the thickness of a film to be coated is only required to have a thickness that the work function of the electron emission surface is sufficiently changed (that is, to make it larger than that of LaB₆) and that evaporation of the material of LaB₆ can be prevented. Note that if carbon is used, it is preferable that the thickness of carbon be set at 2 μm to 10 μm by considering that carbon reacts with oxygen and then evaporates as CO₂.

After that, the tip portion of the electron source 20 is polished together with the coated film so as to have a planar surface with a diameter of 1 μm to 200 μm.

### (Exposure Method)

Next, an exposure method of the exposure apparatus using the electron gun of the present embodiment will be described.

In general, to clean the inside of an electron gun chamber (not shown) in which the electron gun 101, the suppressor electrode 24, the extraction electrode 21, the electrostatic lens electrode 26, and the acceleration electrode 25 are stored, conditioning is carried out in the electron beam exposure apparatus at start of use. In the conditioning, a high voltage, for example, a voltage (80 kV), which is an approximately 1.6 times higher than a voltage (50 kV) normally applied when used, is applied between the electrodes (the electron source 20, suppressor electrode 24, extraction electrode 21, and the electrostatic lens electrode 26) configuring the electron gun 101 and the acceleration electrode 25 so as to cause electric discharge. Thereby, dusts in the inside of the electron gun chamber are removed.

If, in this conditioning, the exposure apparatus has the configuration in which the extraction electrode 21 and the electrostatic lens electrode 26 are not provided by omitting these electrodes and the electron source 20 and the acceleration electrode 25 directly face with respect to each other, electric discharge is caused from the electron source 20. As a result, there is a possibility that the electron source 20 is melted or damaged.

To prevent this, in the conditioning, the extraction electrode 21 is provided, and the potential of this extraction electrode 21 is set to be lower than that of the electron source 20. Thereby, electrons are not extracted from the electron source 20.

After the conditioning for a predetermined period of time, for example, one to several-ten hours, is finished, the voltage to be applied to the entire electron source is returned to the voltage value which is normally used, and the potential of the extraction electrode 21 is set to be higher than that of the electron source 20. Thereby, the normal state of use is set.

In this manner, in the conditioning during which a high voltage is applied to the electrodes, the potential of the extraction electrode 21 is set to be lower than that of the electron source 20. Thus, the extraction of electrons from the electron source 20 can be suppressed, and hence, the melting of the electron source 20 can be prevented.

Note that, in the present embodiment, the tip portion of the electron gun 101 is planarized and the dissimilar substances covering the electron emission surface 20a and the side of the electron source 20 are formed so as to be on the same flat surface. In the above-described embodiment, heat to be applied to the electron source 20 is in an extent that the material configuring the electron source 20 does not cause sublimation. For this reason, the above-described configuration is adopted by considering that the electron source 20 will not be deformed even though an electron beam is emitted.

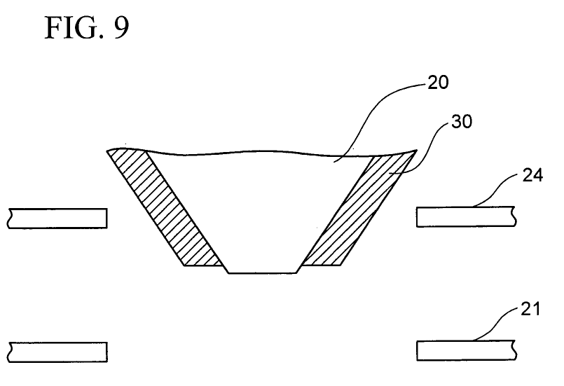

However, even if heat at a predetermined temperature which does not cause sublimation is applied, the temperature may exceed the predetermined temperature for any reason, and consequently, it is possible that the depletion of the electron source material which actually exceeds the predicted range is caused, and that the flat surface cannot be maintained, so that the center would be depressed with time. For this reason, by also taking such a case into consideration, the electron emission surface 20a at the tip of the electron source 20 and the dissimilar material surface in the periphery thereof are not formed on the same flat surface. As shown in FIG. 9, it is also possible that the tip portion including the electron emission surface 20a is formed so as to protrude from the dissimilar material surface.

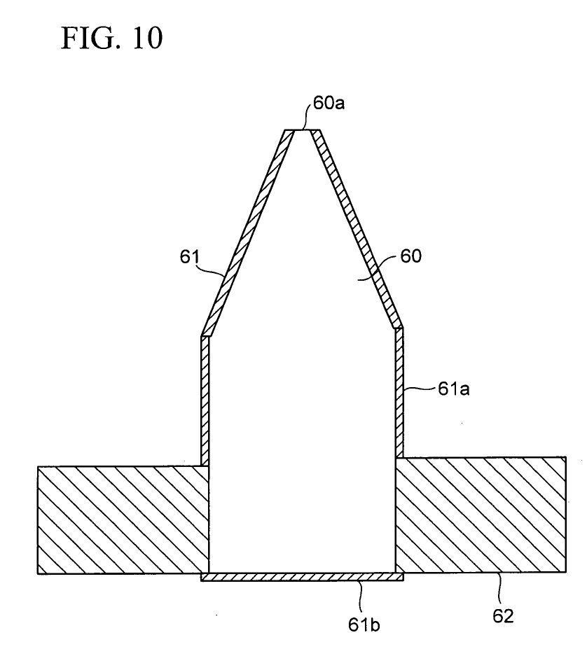

In addition, in the present embodiment, the side surface of the electron source is described as the region which restricts the electron emission. However, it is also possible that side surfaces 61 and 61a of an electron source 60, the side surfaces being other than the electron emission surface 60a and a portion to be sandwiched between carbon chips 62, which are heated by electrification, and a back surface 61b, would be covered with a dissimilar material, as shown in FIG. 10. With this, the sublimation of the electron source 60 can be reduced, and the amount of adherents onto a wehnelt and the like can be reduced.

### (Effects)

As described above, in the present embodiment, the portion of the extraction electrode 21, facing the electron emission surface 20a, is set to be a spherical concave surface. Thereby, the potential distribution between the extraction electrode 21 and the electron emission surface 20a can be made spherical, and thus the potential in the vicinity of the electron emission surface can be made extremely large. Accordingly, even if the thermionic emission type electron gun is operated at a low-temperature, the luminance of electron beam can be made high.

In addition, only the electron emission surface 20a at the tip portion of the chip of the electron source 20 is exposed, and other side portions are covered with a dissimilar material. Since the electron gun 101 having such an electron source 20 is operated at a low-temperature, the sublimation of the chip is hardly caused. With this, the electron gun 101 can be stably used for a longer period of time without deforming the electron emission surface 20a of the electron source 20.

Moreover, an intense electric field is applied to increase the potential in the vicinity of the electron emission surface 20a, so that the electron gun 101 would be operated at a temperature that the sublimation of the chip would not be caused. Even if such an intense electric field is applied, electrons do not emitted from the side surfaces of the electron source 20 because the side surfaces of the electron source 20 are covered with the carbon 30. Thereby, the form of electron beam is not changed, and thus there can be prevented a phenomenon that the degree of vacuum is lowered due to a portion unnecessarily heated to a high temperature.

Furthermore, the exposed surface of LaB₆ is virtually only the center portion of the electron gun. With this, LaB₆ can be prevented from adhering onto the inner surface of a wehnelt due to the sublimation and evaporation from the large area portion, like the side wall portions and the back surface.

When the electron gun 101 of the present invention is used, the generation of sublimation of the electron source 20 can be suppressed and a substance, such as LaB₆ or CeB₆, configuring the electron source 20 can be prevented from adhering onto the back surface of the grid. If these substances adhere onto the back surface of the gird, these adherents become whiskers to accumulate electrons thereon. As a result, micro discharge may be caused. In that case, there is caused a phenomenon that the amount and irradiation position of electron beam become unstable when the electron beam exposure apparatus is used. Accordingly, if it is in a state of causing the micro discharge, even though the deformation of the electron source 20 of the electron gun 101 is small, the electron beam exposure apparatus cannot be stably used.

In the conventional electron gun, it was considered that a time to cause such micro discharge was 100 to 500 hours. In contrast, when the electron gun 101 of the present embodiment is used, as described above, the sublimation of the electron source 20 is hardly caused. Thus, it is made possible that a time to cause the micro discharge is also prolonged several-fold when compared with a conventional one. The reason is that the sublimation of the electron source is reduced in a rage from half, one third, or so to one hundredth because the electron source is used in a temperature lower than the conventional one by 50° C. to 200° C. With this, it is made possible that the time to stably use the electron beam exposure apparatus is prolonged.

Furthermore, by using the electron gun 101 of the present invention in a multicolumn-type electron beam exposure apparatus in which a plurality of electron guns 101 is used to expose light onto one wafer, a time in which the electron beam exposure apparatus can be stably used is considerably prolonged when compared with that of the conventional electron gun. When the conventional electron gun is used, as described above, the micro discharge is caused after the time of 100 to 500 hours of use. Thus, adjustment is needed every time it is used for a short period of time. For this reason, even if a plurality of electron guns are used, the entire apparatus has to be stopped when one of the electron guns becomes unstable. Thus, the operating ratio is decreased, and thus throughput cannot be improved. In contrast, the electron gun of the present embodiment is used in the multicolumn-type electron beam exposure apparatus, so that the operating ratio is not decreased and throughput of exposure processing can be substantially improved.

1. An electron gun comprising:
an electron source which emits an electron;
an acceleration electrode which is disposed to face an electron emission surface of the electron source, and which accelerates the electron;
an extraction electrode which is disposed between the electron emission surface and the acceleration electrode, which has a spherical concave surface having the center on an optical axis, and facing the electron emission surface, and which extracts an electron from the electron emission surface; and
a suppressor electrode which is disposed on the side opposite from the extraction electrode in relation to the electron emission surface, and which suppresses electron emission from a side surface of the electron source,
wherein an electric field is applied to the electron emission surface while the electron source is kept at a low temperature in such an extent that sublimation of a material of the electron source would not be caused, to cause the electron source to emit a thermal field emission electron.

2. The electron gun according to claim 1, wherein the material of the electron source is any one of lanthanum hexaboride (LaB₆) and cerium hexaboride (CeB₆).

3. The electron gun according to claim 2, wherein the side surface of the electron source other than the electron emission surface at a tip portion of the electron source is covered with a substance with a large work function, the substance being different from a substance constituting the electron source.

4. The electron gun according to claim 3, wherein the different substance is carbon.

5. The electron gun according to claim 1, wherein the temperature is in a range from 1100° C. to 1450° C.

6. The electron gun according to claim 1, wherein the extraction electrode is disposed at a distance of 2 mm or less from the electron emission surface.

7. The electron gun according to claim 1, wherein an electrostatic lens electrode is provided between the extraction electrode and the acceleration electrode.

8. The electron gun according to claim 1, wherein the electron emission surface has a flat portion with a diameter in a range from 1 μm to 200 μm.

9. The electron gun according to claim 1, wherein the tip portion of the electron source is substantially conical, and has a conical angle of 50° or less.

10. An electron beam exposure apparatus, comprising the electron gun according to claim 1.

11. An electron beam exposure method using the electron beam exposure apparatus according to claim 10, comprising the following steps of:
applying a voltage so that the potential of the extraction electrode would be lower than the potential of the tip portion of the electron source, and a voltage of the electron source whose absolute value is larger than a voltage value normally used to the entire electron source for a predetermined period of time;
returning the voltage of the electron source to the voltage value normally used; and
applying a voltage so that the potential of the extraction electrode would be higher than the potential of the tip portion of the electron source, to carry out exposure.
